(19) United States
(12) Patent Application Publication
(10) Pub. No.: US 2005/0119932 A1
(43) Pub. Date: Jun. 2, 2005

(54) System and method for visualizing business agreement interactions

(76) Inventors: Ming C. Hao, Palo Alto, CA (US); Umeshwar Dayal, Saratoga, CA (US); Akhil Sahai, Santa Clara, CA (US); Fabio Casati, Palo Alto, CA (US); Vijay Machiraju, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/725,624

(22) Filed: Dec. 2, 2003

(51) Int. Cl. G06F 17/60; G06F 9/44; G06K 9/00

(52) U.S. Cl. 705/10; 705/7; 717/101; 382/113

(57) ABSTRACT

Systems and methods are disclosed for visualizing business agreement interactions. One method embodiment comprises: displaying one or more parties of a first type as nodes in a first region of a view window; displaying one or more parties of a second type as nodes in a second region of the view window; displaying one or more parties of a third type as nodes in a third region that is at least substantially between the first and second region; and displaying agreements between parties as lines between corresponding nodes. The lines may be displayed with at least one characteristic indicative of when a violation of a represented agreement condition has occurred.

### BACKGROUND

Companies make and depend on contractual agreements. For example, a company may invest its manufacturing resources based on contractual agreements with customers, or may invest its marketing resources based on contractual agreements with suppliers. Contractual agreements generally facilitate planning and decision making by establishing prices, quantities, dates, delivery locations, and other necessary details.

As companies struggle to achieve and maintain successful positions in competitive markets, they and their competitors have made changes in their approaches to contractual agreements. Particularly in the high-technology industries, many companies may cooperate in providing a given service or product to a customer. The market's never-ending drive for greater efficiency has produced a high degree of interdependence between such companies. This interdependence often places a company's revenue stream at the mercy of others, and accordingly, companies have developed increasing sophisticated agreements to define and enforce the business agreement.

It is becoming common for a company to find itself part of a network of complex contractual agreements. The network of agreements and the interactions between agreements may be difficult to understand, and hence may be difficult to manage. A company that fails to understand its contractual obligations is likely to make very costly mistakes. Further, such a lack of understanding may prevent a company from learning from mistakes and improving its performance. A system or method of aiding the understanding of a network of contractual agreements would be desirable, particularly if such a system or method could assist in identifying interactions between different contractual agreements in the network and provide other advantages.

### BRIEF DESCRIPTION OF THE DRAWINGS

For a detailed description of various invention embodiments, reference will now be made to the accompanying drawings in which:

FIG. 1 is an external view of an illustrative agreement visualization system in accordance with embodiments of the present invention;

FIG. 2 is a functional block diagram of an illustrative agreement visualization system in accordance with embodiments of the present invention;

FIG. 3 is a functional block diagram of illustrative agreement visualization software in accordance with embodiments of the present invention;

FIG. 4 is an illustrative view of a dependency flow graph for agreement visualization in accordance with embodiments of the present invention;

FIG. 5 is an illustrative view of an occurrence graph for agreement visualization in accordance with embodiments of the present invention;

FIGS. 6a, 6b and 6c show an animation time sequence for the occurrence graph in accordance with embodiments of the present invention; and

FIG. 7 is an illustrative view of a display tree for agreement visualization in accordance with embodiments of the present invention.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed and discussions thereof should not be interpreted, or otherwise used, as limiting the scope of the disclosure or the claims.

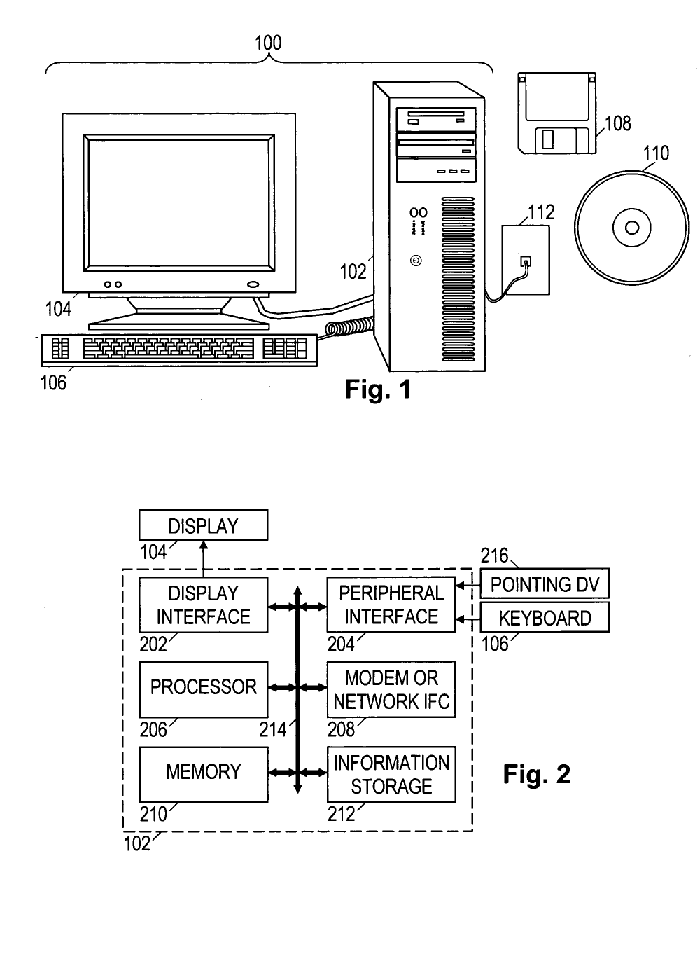

FIG. 1 shows an illustrative system for visualizing an existing or potential network of business agreements. FIG. 1 shows the illustrative system in the form of a desktop computer 100, although any electronic device configured with a graphical user interface and some amount of computing power may be configured to carry out the methods disclosed herein. Among other things, portable computers, personal digital assistants (PDAs) and graphing calculators may be configured to carry out the disclosed decision making methods.

Desktop computer 100 typically includes a chassis 102, a display 104, and an input device 106. The chassis 102 typically includes a processor, memory, and information storage devices. One or more of the information storage devices may store programs and data on removable storage media such as a floppy disk 108 or a compact disc 110. The chassis 102 may further include a network interface that allows the computer 100 to receive information via a wired or wireless network. Collectively, information storage media and information transport media may be termed information carrier media.

The chassis 102 is coupled to the display 104 and the input device 106 to interact with a user. The display 104 and the input device 106 may together operate as a user interface. The display 104 is shown as a video monitor, but may take many alternative forms including a printer, a speaker, or other means for communicating information to a user. The input device 106 is shown as a keyboard, but may similarly take many alternative forms including a button, a mouse, a keypad, a dial, a motion sensor, a camera, a microphone or other means for receiving information from a user. Both the display 104 and the input device 106 may be integrated into the chassis 102.

FIG. 2 shows a simplified functional block diagram of the desktop computer 100. The chassis 102 may include a display interface 202, a peripheral interface 204, a processor 206, a modem or other suitable network interface 208, a memory 210, an information storage device 212, and a bus 214. The computer 100 may be a bus-based system, with the bus 214 interconnecting the other elements and carrying communications between them. The display interface 202 may take the form of a video card or other suitable display interface that accepts information from the bus 214 and transforms it into a form suitable for the display 104. Conversely, the peripheral interface 204 may accept signals from the keyboard 106 and other input devices such as a pointing device 216, and transform them into a form suitable for communication on the bus 214.

The processor 206 gathers information from other system elements, including input data from the peripheral interface 204, program instructions and other data from the memory 210, the information storage device 212, or from a remote location via the network interface 208. The processor 206 carries out the program instructions and processes the data accordingly. The program instructions may further configure the processor 206 to send data to other system elements, including information for the user which may be communicated via the display interface 202 and the display 104.

The network interface 208 enables the processor 206 to communicate with remote systems via a network. The memory 210 may serve as a low-latency temporary store of information for the processor 206, and the information storage device 212 may serve as a long term (but generally high-latency) store of information.

The processor 206, and hence the computer 100 as a whole, typically operates in accordance with one or more programs stored on the information storage device 212. The processor 206 may copy portions of the programs into the memory 210 for faster access, and may switch between programs or carry out additional programs in response to user actuation of the input device. The additional programs may be retrieved from information the storage device 212 or may be retrieved from remote locations via the network interface 208. One or more of these programs may configure the computer 100 to carry out at least one of the agreement visualization methods disclosed herein.

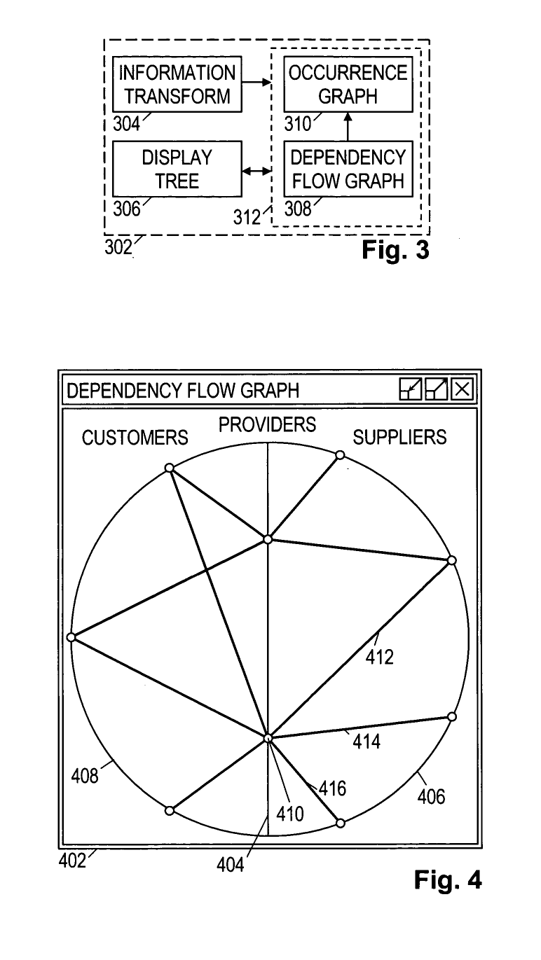

FIG. 3 shows functional components of the illustrative visualization software 302. The software 302 includes an information transform component 304, a monitoring tree component 306, and a graphical display component 312 that includes a dependency flow graph component 308 and an occurrence graph component 310. The information transform component 304 operates to place agreement information into a hierarchical structure such as a tree structure in component 306. The information transform component 304 may take many forms, including (without limitation) a graphical user interface, a parsing routine, a file retriever, or a combination thereof.

In graphical user interface form, the information transform component 304 may gather information directly from a user by providing data entry fields and directing the user regarding the appropriate information to be entered in each field. In parsing form, the information transform component 304 may gather data from an existing file or database. In file retriever form, the information transform component 304 may retrieve an already-constructed data structure such as a file previously created by the software 302. In each of these forms, the information transform component 304 produces a hierarchical data structure 306 containing the agreement information.

In FIG. 3, the information transform component 304 is shown providing hierarchical data structure information to the graphical display component 312. The graphical display component includes a dependency flow graph component 308 and an occurrence graph component 310 that each visually present information from the hierarchical data structure to the user. The user may rely on the display tree component 306 for quick identification of the various elements shown by the graphical display component 312.

The dependency flow graph component 308 may generate a dependency flow graph such as that shown in FIG. 4. FIG. 4 shows a view window 402 having a vertical boundary 404 dividing a circle into two halves bounded by arcs 406 and 408. In the view window 402, the parties are represented as nodes, and agreements are represented as lines between the nodes (excluding boundary lines 404, 406 and 408). Suppliers are distributed evenly along the boundary 406, providers are distributed evenly along the boundary 404, and customers are distributed evenly along the boundary 408. The left side of the view window 402 is thus used to represent business agreements between customers and providers, while the right side of the view window 402 is used to represent business agreements between providers and suppliers.

In one embodiment, the positions of the providers along the center boundary is determined in accordance with the following equations (the center of the view window is assumed to be the origin x=0, y=0):

$$\begin{matrix}{x}_{i} = 0 , \\ {y}_{i} = \frac{R}{n} ( n + 1 - 2 i ) ,\end{matrix} i = 1 , 2 , … , n , \qquad ( 1 )$$

where n is the number of providers, R is the radius of the circle, and (xᵢ,yᵢ) is the position of provider i. The customer positions (xᵢ,yᵢ) may be determined in accordance with the following equations:

$$\begin{matrix}{x}_{i} = R cos {θ}_{i} , \\ {y}_{i} = R sin {θ}_{i} ,\end{matrix} i = 1 , 2 , … , n , and {θ}_{i} = \frac{π}{2 n} ( n - 1 + 2 i ) , \qquad ( 2 )$$

where n is the number of customers. For the supplier positions (xᵢ,yᵢ), only the angle calculation changes:

$$\begin{matrix}{x}_{i} = R cos {θ}_{i} , \\ {y}_{i} = R sin {θ}_{i} ,\end{matrix} i = 1 , 2 , … , n , and {θ}_{i} = \frac{π}{2 n} ( n + 1 - 2 i ) , \qquad ( 3 )$$

where n this time represents the number of suppliers.

The view window 402 shows a line between parties if the parties have one or more current agreements. The line may be shown in a color that represents the presence and severity of violations of the represented agreement(s). For example, a green color may be used to represent an absence of violations or at most violations of a minimal severity. A blue color may represent an average violation level of moderate severity, and a purple color may represent a high violation level.

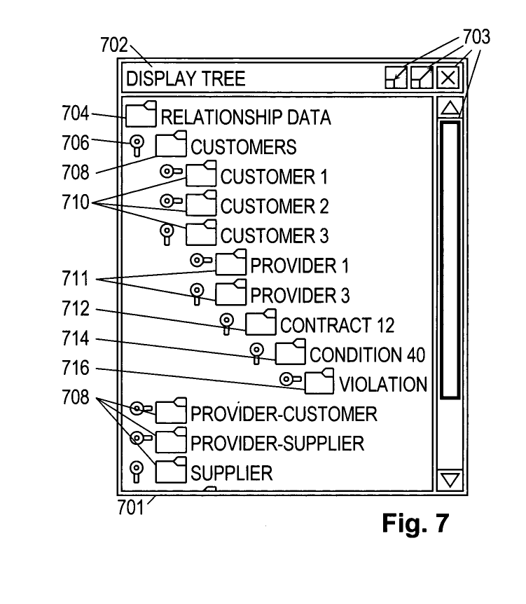

Various portions of the view window 402 may be highlighted or otherwise identified in response to user selection of folders in the view window 702 (described below with respect to FIG. 7). For example, a user's action of selecting a customer type folder may cause the associated nodes and lines 404, 406 or 408 to be highlighted. Selection of a contract folder may cause a line representing that contract to be highlighted. In each case, the highlighting may take any of various suitable forms including a flashing “halo,” a change in color, a change in thickness, a pointing arrow, and/or animation.

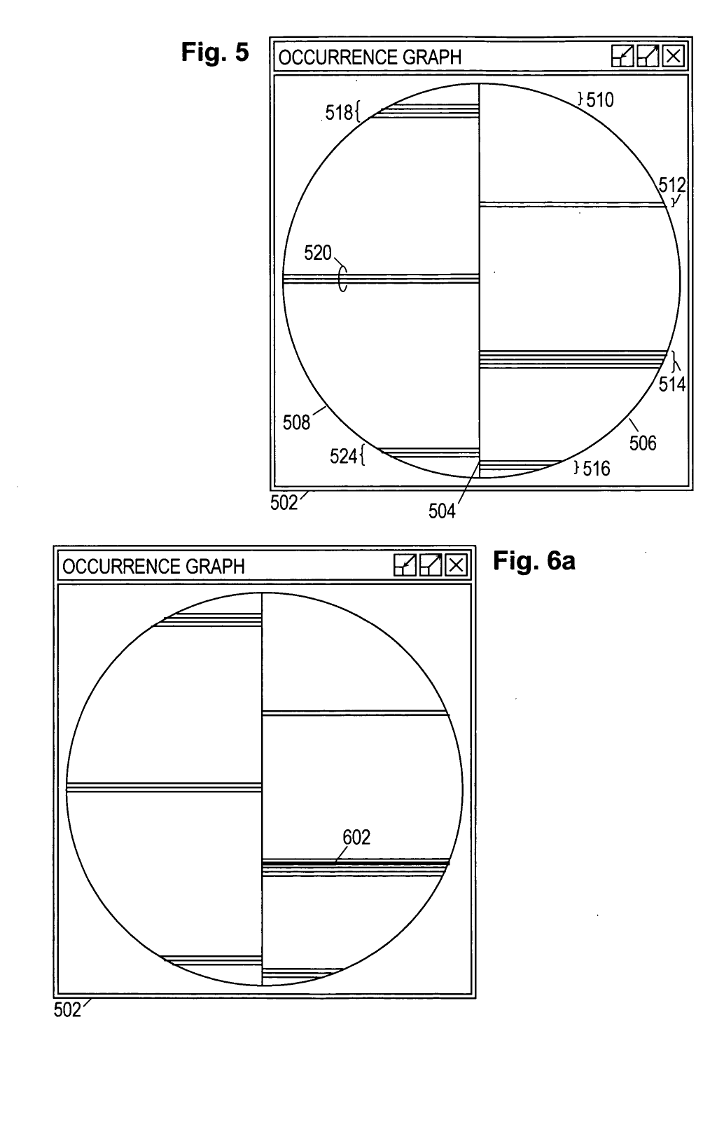

The user may also directly select portions of the view window 402. If a user selects a provider node or a contract line associated with a provider node, the visualization system triggers operation of component 310. Component 310 provides a view window such as that shown in FIG. 5.

FIG. 5 shows a view window 502 that represents all the contracts with a single provider 410 (FIG. 4). In window 502, the provider 410 is represented by the vertical center boundary 504. Horizontal lines are drawn from the center boundary to represent the conditions of the various agreements between the selected provider and the various suppliers and customers. The position of the horizontal lines is indicative of the contract conditions that are represented. Horizontal lines 512 are drawn on the right side of the circle at a position corresponding to the second supplier. These lines represent conditions of a contract between the provider 410 and the second supplier, or more specifically, the contract represented by line 412 of FIG. 4. Similarly, horizontal lines 514 represent conditions of the contract represented by line 414 of FIG. 4, horizontal lines 516 represent conditions of the contract represented by line 416 of FIG. 4. If the provider 410 had a contract with the first supplier, the conditions for that contract would have been represented by the horizontal lines at 510.

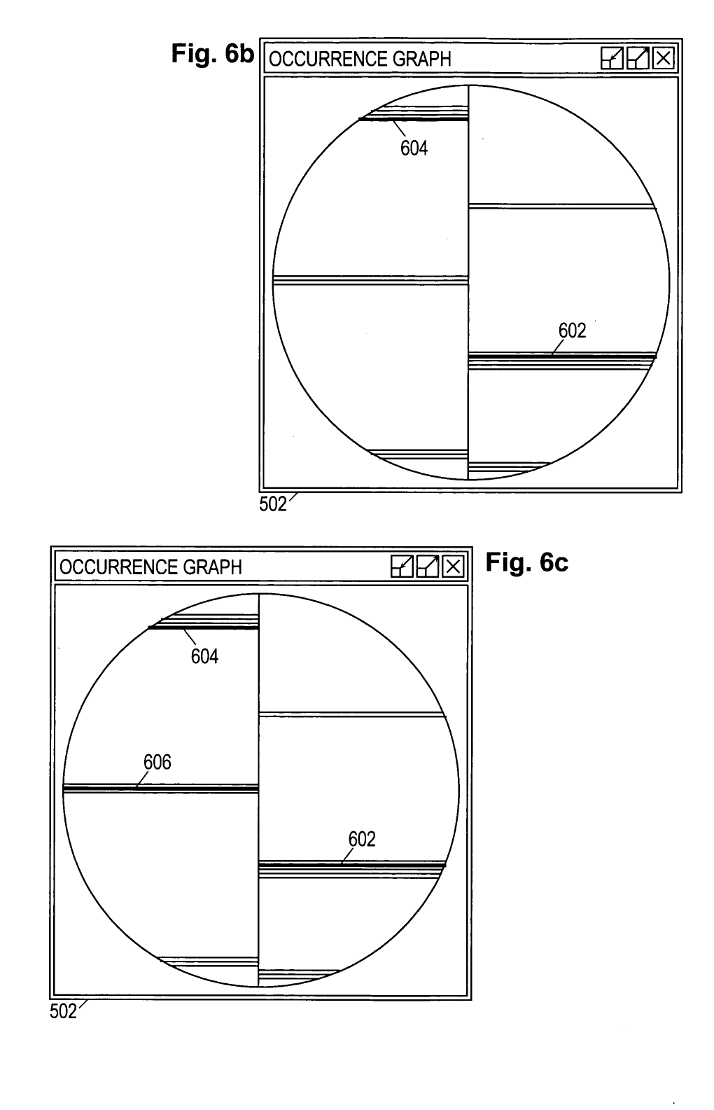

On the left side of the circle, three sets of horizontal lines 518, 520 and 524 represent conditions of the contracts that the provider 410 has with the first, second, and third customers, respectively. The lines may be shown in a color that represents the presence and severity of violations of the represented conditions. As before, green may be used to represent an absence of a violation or at most a violation of minimal severity. A blue color may represent a violation of moderate severity, and a purple color may represent a severe violation. As described below with reference to FIGS. 6a-6c, the view window 502 may show a time sequence of violation states. Accordingly, the line color of a given condition may change as a function of time.

Various portions of the view window 502 may be highlighted in response to user selection of folders in the view window 702 (described below with reference to FIG. 7). For example, a user's action of selecting a condition folder may cause the corresponding horizontal line to be highlighted. As previously mentioned, the highlight may take any of various suitable forms including a flashing “halo,” a change in color, a change in thickness, a pointing arrow, and/or animation.

Each violation has associated with it a time at which the violation occurred. As shown in FIGS. 6a-6c, the view window 502 shows a time sequence of violation states, thereby allowing a user to view the effects of a violation on other contract conditions. Thus, at a first time point, a condition violation 602 is shown in FIG. 6a. This condition violation may be shown by a change in color, line thickness, flashing, animation, and/or a combination thereof. As the view window 502 continues to show the time sequence, a subsequent condition violation 604 appears as shown in FIG. 6b, followed by a third violation 606 as shown in FIG. 6c. A user may intuitively identify a causal connection between the violation 602 and the subsequent violations 604 and 606. A more focused investigation may then provide the details of the causal connection and may aid the user in pursuing available remedies and preventative measures for the future.

The time sequence may be shown in a “loop,” with the view window 502 pausing at the end of the time sequence, indicating a break to the user, and restarting the sequence from the beginning. The break may take any suitable form, including blanking the view window, showing a text message and/or showing a progress bar that indicates the location in the time sequence.

As mentioned above, the software may include a display tree component 306 to aid the user in identifying elements shown by the graphical display component 312. FIG. 7 shows an illustrative display tree that may be provided by the display tree component 306. The display tree is shown in a view window 701 with a standard title 702 and with the standard controls 703 for controlling the window size, for closing the window, and for scrolling through the window contents. The view window 701 shows the hierarchical data structure as a list of labeled folders indented horizontally according to their hierarchical level. (For example, folder 704 is a Level 0 folder.)

Associated with each folder (except perhaps the root folder 704) is an indicator 706 that indicates whether the folder is “open” or “closed.” When the indicator 706 is oriented vertically, the folder is open, meaning that subordinate entries are shown. When the indicator 706 is oriented horizontally, the folder is closed, meaning that no subordinate entries are shown. To toggle between open and closed states, the user may select (e.g., with a mouse click) the indicator. The component 306 will display the appropriate entries from the view window 701.

In one embodiment, the hierarchical data structure has the following organization (others would also be suitable):
Level 0: Business agreement Data
Level 1: Party Type
Level 2: First Party
Level 3: Second Party
Level 4: Agreement
Level 5: Condition
Level 6: Occurrence

At the highest level (Level 0) is a root, or starting point, for the hierarchical structure. The root includes a list of party types (Level 1), e.g., customer, provider, and supplier. Other types of parties to business agreements may potentially be included. (Depending on the number of parties involved, it may be convenient to subdivide the provider type based on the different agreement types the provider supports, namely, “provider-customer” and “provider-supplier.”) At Level 1, each of the three (or four) party types is listed.

At Level 2, each party of a given party type is listed. The list of parties for a given party type may be empty if the contemplated agreement situation does not include parties of that type. The parties may be identified in any suitable way, including without limitation, a company name, or abbreviation thereof. Each party may also have associated with it a list of parties (Level 3) with whom a current agreement exists.

At Level 3, each party with whom a current agreement exists is listed. Thus, for example, a customer company with the hypothetical name “Customer 3” may have agreements with two different providers hypothetically named “Provider 1” and “Provider 3.” In the hierarchical structure below the entry for Customer 3, entries would be provided for Provider 1 and Provider 3. A list of current agreements (Level 4) between the Level 2 party and Level 3 party may be associated with each of the Level 3 entries.

At Level 4, an entry is provided for each current agreement. For example, if only one agreement exists between Customer 3 and Provider 3, only one Level 4 entry would appear below the Provider 3 entry at Level 3.

At Level 5, each agreement entry may include one or more condition entries. Conditions may be thought of as components of each agreement. For example, an agreement to deliver 500 premium widgets before the end of the quarter has three conditions: quantity, quality, and date. Thus the agreement could be violated in at least three different ways (e.g., not enough widgets delivered, widgets are of inferior quality, or the delivery occurs late).

At Level 6, each condition entry may include one or more occurrence entries. Occurrence entries indicate an occurrence such as a violation of the condition and may include some indication of severity and a description of how the condition was violated. For example, the violation occurrence entry may indicate “1 day late,” “3 widgets short,” or “no delivery.” The occurrence entries may also include an indication of the time at which a violation occurred (which may often be the originally scheduled delivery date).

Returning to FIG. 7, a data hierarchy is shown in the view window 701. Folder 704 is a level 0, or “root” folder, and accordingly is not indented. Folders 708 are level 1 folders that list party types, and accordingly, they are indented by one position. The indicator 706 shows that the customers folder is open, and indeed, the view window 701 shows the level 2 folders 710 identifying the three customer companies in the example scenario: Customer 1, Customer 2, and Customer 3.

The Customer 3 folder is open, showing the level 3 folders 711. The folders 711 identify the parties with which Customer 3 has current agreements: Provider 1 and Provider 3. The Provider 3 folder is open, showing the current agreement between Provider 3 and Customer 3 as a level 4 folder 712. Within the agreement folder is a single condition folder 714, which in turn contains an occurrence folder 716. Those persons experienced in operating modern computers will find it easy to navigate through the data hierarchy using the view window 701. As various folders are selected (perhaps by “double-clicking” with a pointing device), corresponding elements in the view window 402 or the view window 502 may be highlighted or otherwise identified to the user.

The above discussion is only meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method of visualizing business agreement interactions, the method comprising:
dividing parties into at least three types;
displaying one or more parties of a first type as nodes in a first region of a view window;
displaying one or more parties of a second type as nodes in a second region of the view window;
displaying one or more parties of a third type as nodes in a third region of the view window, wherein the third region is at least substantially between the first and second region; and
displaying agreements between parties as lines between corresponding nodes.

2. The method of claim 1, wherein the one or more parties of the first type are suppliers for the one or more parties of the third type.

3. The method of claim 2, wherein the one or more parties of the second type are customers for the one or more parties of the third type.

4. The method of claim 1, wherein the first region is an arc of a circle, and wherein the second region is an opposing arc of the circle.

5. The method of claim 4, wherein the third region is a circle diameter that separates the first and second regions.

6. The method of claim 1, wherein the third region is a line separating the first and second regions.

7. The method of claim 1, wherein said lines are displayed with at least one characteristic indicative of whether a violation has occurred.

8. The method of claim 7, wherein said at least one characteristic is color.

9. The method of claim 7, wherein said at least one characteristic is animation.

10. The method of claim 7, wherein said at least one characteristic is further indicative of a violation severity.

11. The method of claim 1, further comprising:
displaying a hierarchical tree of business agreement information; and
highlighting associated items in the view window as a user selects items in the hierarchical tree.

12. The method of claim 1, further comprising:
displaying agreement conditions between the one or more parties of the first type and a particular party of the third type as parallel lines in one window region;
displaying agreement conditions between the one or more parties of the second type and the particular party of the third type as parallel lines in a second window region; and
changing one or more of the parallel lines as a function of time to display violations as a function of time.

13. A method of visualizing business agreement interactions, the method comprising:
displaying agreement conditions between a first party and one or more parties of a first type as one or more noncrossing groups of parallel lines in one region of a view window; and
displaying agreement conditions between the first party and one or more parties of a second type as one or more noncrossing groups of parallel lines in a second region of a view window,
wherein said lines are displayed with at least one characteristic indicative of whether a violation of a represented agreement condition has occurred.

14. The method of claim 13, wherein the first party is represented by a line separating the first region from the second region.

15. The method of claim 13, wherein said at least one characteristic is color.

16. The method of claim 13, wherein said displaying actions are animated to show a violation occurrence sequence over time.

17. The method of claim 13, wherein said at least one characteristic is further indicative of a violation severity.

18. The method of claim 13, further comprising changing the view window as a function of time to display a time sequence of violations.

19. The method of claim 13, wherein parties of the first type are suppliers of the first party, and wherein parties of the second type are customers of the second party.

20. The method of claim 13, wherein agreement conditions between the parties are shown are shown as a time series to indicate an order in which violations occur.

21. An information carrier medium configured to provide software for visualizing business agreement interactions to a computer, wherein the software configures the computer to:
divide parties into at least three types;
display one or more parties of a first type as nodes in a first region of a view window;
display one or more parties of a second type as nodes in a second region of the view window;
display one or more parties of a third type as nodes in a third region of the view window, wherein the third region is at least substantially between the first and second region; and
display agreements between parties as lines between corresponding nodes.

22. The medium of claim 21, wherein the one or more parties of the first type are suppliers for the one or more parties of the third type, and wherein the one or more parties of the second type are customers for the one or more parties of the third type.

23. The medium of claim 21, wherein said lines are displayed with at least one characteristic indicative of whether a violation has occurred.

24. The medium of claim 21, wherein the software further configures the computer to:
display agreement conditions between the one or more parties of the first type and a particular party of the third type as parallel lines in one window region;
display agreement conditions between the one or more parties of the second type and the particular party of the third type as parallel lines in a second window region; and
change one or more of the parallel lines as a function of time to display violations as a function of time.

25. An information carrier medium configured to provide software for visualizing business agreement interactions to a computer, wherein the software configures the computer to:
display agreement conditions between a first party and one or more parties of a first type as one or more noncrossing groups of parallel lines in one region of a view window; and
display agreement conditions between the first party and one or more parties of a second type as one or more noncrossing groups of parallel lines in a second region of a view window,
wherein said lines are displayed with at least one characteristic indicative of whether a violation of a represented agreement condition has occurred.

26. The medium of claim 25, wherein the first party is represented by a line separating the first region from the second region.
